(19) United States
(12) Patent Application Publication
(10) Pub. No.: US 2014/0263133 A1
(43) Pub. Date: Sep. 18, 2014

(54) ADAPTER CLIP

(71) Applicants: William H. Walker, Fairlawn, OH (US); Gregory M. Bird, Solon, OH (US); Shane Obitts, Elyria, OH (US)

(72) Inventors: William H. Walker, Fairlawn, OH (US); Gregory M. Bird, Solon, OH (US); Shane Obitts, Elyria, OH (US)

(73) Assignee: Fasteners For Retail, Inc., Twinsburg, OH (US)

(21) Appl. No.: 13/828,595

(22) Filed: Mar. 14, 2013

(51) Int. Cl. F16B 2/22; A47F 5/00

(52) U.S. Cl. CPC F16B 2/22; A47F 5/005
USPC 211/184; 24/561; 29/525.08

(57) ABSTRACT

The present disclosure pertains to a divider including an elongated base member having a first surface configured to abut a shelf and an opposite second surface. A divider wall extends from the second surface of the elongated base member. A recess portion is located along the first surface and is configured to be connectable to a first type of associated rail. An adapter clip is configured to be selectively inserted within the recess portion to allow the divider assembly to be connectable to a second type of associated rail. The adapter clip includes a base member having a first end and an opposing second end. A first support arm extends from the first end and a second support arm extends from the second end. A ridge profile of the clip is configured to be selectively received within a lip of the recess portion of the elongated base member.

### BACKGROUND

The present disclosure relates to an adapter clip for a divider that is configured to connect to a first type of rail employed on a merchandising shelf. It finds particular application in conjunction with an adaptable clip that can removeably attach to the divider thereby allowing the divider to connect to a second type of rail employed on a merchandising shelf, and will be described with particular reference thereto. However, it is to be appreciated that the present exemplary embodiment is also amenable to other like applications.

Merchandising shelf assemblies are generally arranged to stock, store or display various products or merchandise in a desirable way. Many stores sell various retail items that have differing geometric shapes and dimensions and it is desirable to provide shelf assemblies that are individually configurable to stock, store or display the various products in various arrangements. It has now become common to provide facing systems which include dividers that are mounted to a rail, such as a front rail, which in turn is mounted to a shelf to separate the products thereon into columns.

Shelf dividers neatly separate multiple products on a single shelf. Dividers are used to increase sales and enhance presentation. Multiple sizes and styles are available. In many instances, the dividers connect to the shelf via an elongated mounting member, such as a rail. The rail can include a vertically oriented wall or fence positioned along a front edge of the shelf to prevent product from falling from the shelf. The rail can also include an attachment profile positioned adjacent to the front edge that runs lengthwise along the shelf. The divider, or a plurality of dividers, is adapted to connect to the rail along the attachment profile at a desired position on the shelf. The attachment profile is adapted to support the divider and retard movement thereof while also allowing a user to adjust the location of the divider along the shelf.

There are different attachment profiles that are associated with different currently available rails and existing dividers for merchandising shelf assemblies. Shelving manufacturers sell the dividers and rails as a system as the dividers are designed to for connection to the attachment profile of the rail associated with that system. A problem can exist when a merchant has many different shelving systems with dividers and rails of different configurations. For example, a merchant may have a first type of divider that is configured to attach to a rail having a first type of attachment profile, however, the existing shelf includes a rail having a different, second type of attachment profile.

Therefore, a need exists to provide an adapter member that is configured to connect the first type of divider having a first attachment profile to a rail having a second attachment profile.

### BRIEF DESCRIPTION

In one embodiment the present disclosure pertains to a divider assembly including an elongated base member having a first surface configured to abut a shelf and an opposite second surface. The assembly includes a divider wall that extends from the second surface of the elongated base member. A recess portion is located along the first surface of the elongated base member and is configured to be connectable to a first type of associated rail. An adapter clip is configured to be selectively inserted within the recess portion to allow the divider assembly to be connectable to a second type of associated rail.

The adapter clip can include a base member having a first end and an opposing second end. A first support arm extends from the first end and a second support arm extends from the second end such that at least one of the first end and the second end includes a ridge profile that is configured to be selectively received within a lip of the recess portion of the elongated base member.

In another embodiment of the present disclosure, provided is an adapter clip for a divider configured to be connected to a first type of associated rail, wherein the adapter clip enables the divider to be connected to a second type of associated rail. The adapter clip includes a base member having a first end and an opposing second end, a first support arm extending from the first end and a second support arm extending from the second end wherein the first support arm and second support arm extend from the base member and define a channel that is configured to receive a portion of the associated second type of rail. A ridge profile is positioned along at least one of the first end and the second end of the base member such that that adapter clip can be selectively inserted within the divider to couple the divider to the associated second type of rail.

The divider includes an elongated base member having a first surface configured to abut an associated shelf and an opposite second surface. A divider wall extends from the second surface of the elongated base member. A recess portion is located along the first surface of the elongated base member. The recess portion includes a seat surface having a lip, a back surface and an end wall that is configured to receive the adapter clip such that the adapter clip is configured to abut the seat surface.

In still another embodiment, a method is provided for connecting a divider adapted for use with a first type of rail to a second type of rail via an adapter clip. The method includes the steps of providing a divider having an elongated base member with a first surface and an opposite second surface such that a divider wall extends from the second surface of the elongated base member. A recess portion is provided along the first surface of the elongated base member. The recess portion includes a seat surface having a lip, a back surface and an end wall configured to connect to the first type of rail. An adapter clip is inserted into the recess portion along the seat surface. The adapter clip includes a base member with a first end and an opposing second end such that a first support arm extends from the first end and a second support arm extends from the second end wherein the first support arm and second support arm extend from the base member and define a channel. A ridge profile is positioned along at least one of the first end and the second end of the base member of the adapter clip and is forced against the lip of the recess portion to lock the adapter clip within the recess portion. The divider is coupled to the second type of rail.

### BRIEF DESCRIPTION OF THE DRAWINGS

The present disclosure may take form in certain parts and arrangements of parts, several embodiments of which will be described in detail in this specification and illustrated in the accompanying drawings which form a part hereof and wherein:

FIG. 1 is an exploded side elevational view of a portion of a divider and an adapter clip according to a first embodiment of the present disclosure;

FIG. 2 is an assembled side elevational view of the divider and adapter clip of FIG. 1;

FIG. 3 is a bottom plan view of the divider and adapter clip of FIG. 2 according to the present disclosure;

FIG. 4 is a partial side elevational view of the divider of FIG. 1, without the clip, attached to a first type of rail;

FIG. 5A is a greatly enlarged bottom perspective view of the adapter clip of FIG. 1 according to the present disclosure;

FIG. 5B is an enlarged partial bottom perspective view of the divider of FIG. 1 according to the present disclosure;

FIG. 6 is a top plan view of a shelving assembly including the divider and adapter clip of FIG. 2 as mounted on a second type of rail;

FIG. 7 is an exploded side elevational view of the divider of FIG. 1 and another embodiment of an adapter clip according to the present disclosure;

FIG. 8 is an assembled side elevational view of the divider and the adapter clip of FIG. 7 according to the present disclosure;

FIG. 9 is a bottom plan view of the divider and the adapter clip of FIG. 8;

FIG. 10 is a bottom perspective view of the divider and the adapter clip of FIG. 8 according to the present disclosure;

FIG. 11 is a greatly enlarged perspective bottom view of the adapter clip of FIG. 7; and

FIG. 12 is a perspective top view of the adapter clip of FIG. 11.

### DETAILED DESCRIPTION

It is to be understood that the detailed figures are for purposes of illustrating exemplary embodiments of the present disclosure only and that the figures and the detailed description are not intended to be limiting. Additionally, it will be appreciated that the drawings are not to scale and that portions of certain elements may be exaggerated for the purpose of clarity and ease of illustration.

In accordance with the present disclosure, FIG. 1 illustrates a divider 100 that includes an elongated base member 110 having a first or bottom surface 120 that is configured to abut an associated shelf (not shown) and an opposite second or top surface 130. The bottom surface 120 is oriented generally parallel to the top surface 130 such that the elongated base member 110 is generally rectangular in shape. A divider wall 140 extends from or protrudes from the top surface 130 of the elongated base member 110 in a generally perpendicular orientation.

A transverse slot or recess portion 150 is defined in the first surface 120 of the elongated base member 110. The recess portion 150 has a profile which is configured to be connectable to a first type of rail 155 (see FIG. 4). The recess portion 150 is located adjacent a first end 310 of the elongated base member 110. An adapter clip 160 is configured to be selectively inserted within the recess portion 150 to allow the divider 100 to be connectable to a second type of associated rail (see FIG. 6). With reference now to FIG. 5A, the adapter clip 160 includes a base member 170 having a first end 180 and an opposing second end 190. A first support arm 200 extends from the first end 180 and a second support arm 210 extends from the second end 190, with the two arms defining a channel 195 therebetween. The channel 195 is configured to receive a portion of the second type of rail (shown in FIG. 6).

With reference now to FIG. 5B, the recess portion 150 is defined by a seat surface 270 having a lip 230, a back surface 280 and an end wall 290. In this embodiment, the lip 230, the back surface 280 and the end wall 290 extend the width of the elongated base member 110. The end wall 290 extends inwardly from and is oriented generally transverse to the first surface 120. The back surface 280 extends from the end wall 290 and is oriented generally parallel to the first surface 120. The lip 230 protrudes from the back surface 280 and defines a groove 300 therebetween. The adapter clip 160 is configured to abut the seat surface 270 in an attached position as illustrated by FIGS. 2 and 3. The adapter clip 160 includes a ridge profile 220 that is adapted to be selectively received past the lip 230 and within the groove 300. The ridge profile 220 of the adapter clip 160 is configured to frictionally abut the lip 230 to and hold the adapter clip 160 in the recess portion 150 of the elongated base member 110.

In the attached position, the base member 170 of the adapter clip 160 abuts the back surface 280 while the first support arm 200 abuts against the end wall 290 of the recess portion 150 along the elongated base member 110.

FIG. 2 illustrates the divider 100 with the adapter clip 160 in place in the recess portion 150. The groove 300 defined by the lip 230 and the back surface 280 is directed inwardly towards the elongated base member 110. A slope surface 234 defines a notch portion 236 and is located on the side of the lip 230 opposite the groove 300. The notch portion 236 extends from a pinnacle edge 238 of the lip 230 to the first end 310 of the elongated base member 110 and can include reinforcing rib members 320 (FIG. 3) therein.

In the embodiment shown in FIG. 3, the adapter clip 160 further includes a plurality of first teeth members 240 positioned along the first support arm 200 wherein the first teeth members 240 are configured to cooperate with corresponding teeth members 250 located along the end wall 290 of the recessed portion 150. This configuration retards lateral movement of the adapter clip 160 within the recess portion 150. A plurality of second teeth members 260 are positioned along the second support arm 210 and extend in a direction toward the channel 195 defined between the first and second support arms. The second teeth members 260 are configured to cooperate with corresponding teeth members 420 positioned along the second type of rail 410 (FIG. 6) to retard lateral movement of the divider 100 relative to the second type of rail as it is installed on the shelf.

A plurality of reinforcing ribs 320 can depend from the base member 110 and provide structural support thereon. Additionally, a side wing 330 can extend from one side of the elongated base member 110. The side wing 330 includes an edge 335 that is generally aligned with the end wall 290 so that it does not interfere with the first or second type of rail as the divider assembly is attached thereto.

FIG. 4 illustrates the first type of rail 155 as it is connected to the divider 100. The first type of rail 155 includes an elongated profile portion 165 spaced from an elongated groove 175. The groove is configured to receive and support a vertically oriented fence or wall (not shown). The recess portion 150 defines the channel 195 that is configured to receive a desired portion of the elongated profile 165 along the first type of rail 155. The elongated profile 165 includes a ridge 185 along one side towards the groove 175 and a plurality of teeth 187 positioned along the opposite side. The plurality of teeth 187 are configured to cooperate with the plurality of teeth 250 positioned along the end wall 290 within the recess portion 150. The ridge 185 is configured to overcome the lip 230 and come to rest within the groove 300 of the recess portion 150 to lock the divider 100 to a desired position along the first type of rail 155.

FIG. 5A shows an greatly enlarged illustration of the adapter clip 160 that is configured to be inserted into the transverse slot 150 of the divider assembly 100 illustrated in FIG. 5B. The first support arm 200 extends from the first end 180 and a second support arm 210 extends from the second end 190 in a generally parallel orientation to define the channel 195. The ridge profile 220 extends the width of the adapter clip 160 along the intersection of the second end 190 and the second support arm 200. The plurality of first teeth members 240 are positioned along the first support arm 200. In one embodiment, the first teeth members 240 include a first end 350 that align along a first edge 340 of the first support arm 200 and extend along a portion of an outside surface 380 of the first support arm 200. In this embodiment, the first teeth members 240 do not extend down the entire length of the outside surface 380 thereby leaving a space 370. The plurality of first teeth members 240 having a second end 360 that is tapered or rounded and configured to provide some measure of self-alignment with the plurality of corresponding teeth members 250 on the end wall 290 as the adapter clip 160 is inserted into the recess portion 150. The space 370 between the first end 180 of the base member 170 and the second end 360 of the plurality of first teeth members 240 allows a user to bias or slightly bend the adapter clip 160 against the end wall 290 as the ridge profile 220 frictionally engages the pinnacle edge 238 of the lip 230. In this manner, the adapter clip 160 is received or removed from the recess portion 150 such that the plurality of first teeth members 240 are not engaged to the plurality of corresponding teeth members 250 on the end wall 290 at this time.

The plurality of second teeth members 260 protrude inwardly towards the channel 195 from the second arm 210. The second teeth members 260 extend along an inner surface 400 from a second edge 390 of the second arm 210 to the base member 170.

As illustrated in FIG. 6 and as viewed from the top, the divider 100 is configured to attach to a second type of rail 410 when the adapter clip 160 is inserted within the recess portion 150. The second type of rail 410 is attached to a shelf (not shown) and comprises a first leg or profile 430 including a plurality of spaced teeth 420 located on a first face that are configured to selectively cooperate with the plurality of second teeth members 260 spaced along the second arm 210 of the adapter clip 160 within the elongated base member 110 (see FIG. 5A). The leg 430 of the second type of rail 410 also includes a planar face 440 located on a second face opposite from the first face supporting the teeth 420. The adapter clip 160 is adapted to selectively receive the leg 430 of the second type of rail 410 to support the divider 100 in a generally transverse upright position relative to the shelf.

The second type of rail 410 is configured to be received within the channel 195 of the adapter clip 160 in a similar orientation as the first type of rail 155 illustrated by FIG. 4 is received by the divider 100 in the absence of the clip. However, the second type of rail includes a profile having a plurality of rail teeth positioned at a different location than the first type of rail. The adapter clip 160, in effect, repositions the teeth of the divider 100 thereby allowing a user to selectively adapt the divider 100 to either the first type of rail 155 or second type of rail 410 with the addition of the adapter clip 160.

FIGS. 7-12 illustrate a second embodiment of an adapter clip 160′ wherein like features have reference numbers with a primed (′) suffix and new features have new reference numbers. In this embodiment, the adapter clip 160′ includes a panel 450 that extends from the second support arm 210′ and is adapted to abut the sloped surface 234 of the notch portion 238 of the elongated base member 110. The lip 230 is located between the notch portion 236 and the groove 300. The panel 450 extends from the second support arm 210′ and is generally sloped relative to a base member 170′ of the adapter clip 160′. The panel 450 is adapted to allow a user to urge the panel 450 away from the sloped surface of the divider 100 and to easily remove the adapter clip 160′ from the recess portion 150.

The panel 450 can include a pair of support members 460 that extend upwardly from the panel 450 to engage the reinforcement ribs 320 positioned adjacent to the sloped surface 234 along the notched portion 236. In this embodiment, the panel 450 substantially covers the sloped surface 234. As more clearly shown by FIG. 8, when the adapter clip 160′ with the panel 450 is received by the recess portion 150 of the elongated base member 110, a ledge portion 470 of the panel 450 protrudes outwardly from the perimeter of the elongated base member 110. A user can easily remove the adapter clip 160′ by depressing the ledge portion 470 such that a ridge profile 220′ is released from the groove 300 and passes the lip 230 of the recess portion 150.

FIGS. 11 and 12 show a greatly enlarged illustration of the adapter clip 160′ that is configured to be inserted into the transverse slot 150 of the divider assembly 100 illustrated in FIG. 10. A first support arm 200′ extends from a first end 180′ and the second support arm 210′ extends from a second end 190′ of the adapter clip 160′ in a generally parallel orientation to define a channel 195′. The ridge profile 220′ extends the width of the adapter clip 160′ along the intersection of the second end 190′ and the second support arm 200′. A plurality of first teeth members 240′ are positioned along the first support arm 200′. In one embodiment, the first teeth members 240′ each include a first end 350′ that aligns along a first edge 340′ of the first support arm 200′ and extend along a portion of an outside surface 380′ of the first support arm 200′. In this embodiment, the first teeth members 240′ do not extend down the entire length of the outside surface 380′ thereby leaving a space 370′. The plurality of first teeth members 240′ having a second end 360′ that is tapered or rounded and configured to provide some measure of self-alignment with the plurality of corresponding teeth members 250 on the end wall 290 as the adapter clip 160′ is inserted into the recess portion 150. The space 370′ between the first end 180′ of the base member 170′ and the second end 360′ of the plurality of first teeth members 240′ allows a user to bias or slightly bend the adapter clip 160′ against the end wall 290 as the ridge profile 220′ frictionally engages the pinnacle edge 238 of the lip 230. In this manner, the adapter clip 160′ is received or removed from the recess portion 150 such that the plurality of first teeth members 240′ are not engaged with the plurality of corresponding teeth members 250 on the end wall 290 at this time.

A plurality of second teeth members 260′ protrude inwardly towards the channel 195′ from the second arm 210′. The second teeth members 260′ extend along an inner surface 400′ from a second edge 390′ of the second arm 210′ to the base member 170′. The panel 450 aligns with the second edge 390′ and angles downwardly (FIG. 11) from the second arm 210′ such that the panel 450 generally conforms to the slope surface 234 of the elongated base member 110. In this embodiment, the flange member 470 has a planar orientation and is generally aligned along a common plane as the base member 170′ of the adapter clip 160′. As shown in FIG. 12, the support members 460 extend from an upper side of the panel 450 and the flange member 470 to engage ribbed members within the notch portion 236 (FIG. 5B) of the elongated base member 110.

The adapter clip 160, 160′ can be used in a method of connecting the divider 100 adapted for use with the first type of rail 155 to the second type of rail 410. The divider assembly 100 is provided with the elongated base member 110 having the first surface 120 and the opposite second surface 130 such that the divider wall 140 extends from the second surface 130 of the elongated base member 110 in a generally transverse orientation. The recess portion 150 is located along the first surface 120 of the elongated base member 110 and includes seat surface 270 that is defined by the lip 230, the back surface 280 and the end wall 290 which extend the width of the elongated base member 110. The seat surface 270 is configured to be selectively connected to the elongated profile 165 of the first type of rail 155.

The adapter clip 160, 160′ can be inserted into the recess portion 150 along the seat surface 270 such that the adapter clip 160, 160′ retards axial movement therein. In one embodiment, the adapter clip 160 includes the base member 170 with the first end 180 and the opposing second end 190 such that the first support arm 200 extends from the first end 180 and the second support arm 210 extends from the second end 190. The first support arm 200 and the second support arm 210 extend from the base member 170 in a generally parallel orientation to define the channel 195.

As the adapter clip 160 is inserted into the recess portion 150, the ridge profile 220 positioned along the second end 190 of the base member 170 is forced against the pinnacle edge 238 of the lip 230. The base member 170 bends or biases due to the forces acting on the adapter clip 160 to allow the ridge profile 220 to overcome the lip 230 and come to rest within the groove 300 of the recess portion 150 to lock the adapter clip 160 therein. The first teeth members 240 are generally self-aligned with the cooperating teeth members 250 along the end wall 290. The divider assembly can now be coupled to a shelf that includes the second type of rail wherein the second type of rail profile includes rail teeth positioned along a surface that faces towards the second teeth members 260 within the channel 195. The second type of rail is inserted into the channel 195 of the adapter clip 160 to couple the divider 100 to the shelf wherein unwanted axial movement of the divider 100 relative to the shelf is prevented.

In another embodiment, the adapter clip 160′ includes the panel 450 that can assist a user to remove the adapter clip 160′ from the divider 100 by depressing the panel 450. The panel 450 extends from the second support arm 210′ of the adapter clip 160′ and is configured such that the ridge profile 220′ can more easily pass the lip 230 of the recess portion 150.

The exemplary embodiments of the disclosure have been described herein. Obviously, modifications and alterations will occur to others upon reading and understanding the preceding detailed description. It is intended that the instant disclosure be construed as including all such modifications and alterations insofar as they come within the scope of the appended claims or the equivalents thereof.

1. A divider assembly comprising:
an elongated base member having a first surface configured to abut an associated shelf and an opposite second surface;
a divider wall extending from the second surface of the elongated base member;
a recess portion located along the first surface of the elongated base member and configured to be connectable to a first type of associated rail; and
an adapter clip configured to be selectively inserted within the recess portion to allow the divider assembly to be connectable to a second type of associated rail.

2. The divider assembly according to claim 1, wherein the adapter clip comprises:
a base member having a first end and an opposing second end; and
a first support arm extending from the first end and a second support arm extending from the second end such that at least one of the first end and the second end includes a ridge profile that is configured to be selectively received within a lip of the recess portion of the elongated base member.

3. The divider assembly according to claim 2, wherein the ridge profile of the adapter clip is configured to frictionally abut the lip to selectively insert and remove the adapter clip from the recess portion of the elongated base member.

4. The divider assembly according to claim 2, wherein the adapter clip further comprises a plurality of first teeth members positioned along the first support arm wherein the first teeth members are configured to align with corresponding teeth members positioned within the recessed portion to prevent lateral movement of the adapter clip within the recess portion.

5. The divider assembly according to claim 2, wherein the adapter clip further comprises a plurality of second teeth members positioned along the second support arm, the second teeth members being configured to align with corresponding teeth members positioned along the associated second type of rail to prevent lateral movement of the divider assembly relative to an associated shelf.

6. The divider assembly according to claim 2, wherein the recessed portion includes a groove adjacent to the lip.

7. The divider assembly according to claim 6, wherein a sloped surface extends from the lip to define a notch portion that is adapted to the profile of at least one of the adapter clip and the second type of rail.

8. The divider assembly according to claim 2, wherein the adapter clip further comprises a panel that extends from the second support arm and is adapted to abut a sloped surface along a notch portion of the elongated base member wherein the lip is located between the notch portion and the recessed portion along the elongated base member.

9. The divider assembly according to claim 2, wherein the adapter clip further comprises a panel that extends from the second support arm and is generally sloped relative to the base member of the adapter clip.

10. The divider assembly according to claim 7, wherein the adapter clip further comprises a panel that extends from the second support arm and is adapted to align along the sloped surface.

11. An adapter clip for a divider configured to be connected to a first type of associated rail, the adapter clip enabling the divider to be connected to a second type of associated rail comprising:
a base member having a first end and an opposing second end;
a first support arm extending from the first end;
a second support arm extending from the second end wherein the first support arm and second support arm extend from the base member and define a channel that is configured to receive a portion of the associated second type of rail; and
a ridge profile positioned along at least one of the first end and the second end of the base member such that that adapter clip can be selectively inserted within the divider to couple the divider to the associated second type of rail.

12. The adapter clip according to claim 11, wherein the divider further comprises:
an elongated base member having a first surface configured to abut an associated shelf and an opposite second surface;
a divider wall extending from the second surface of the elongated base member;
a recess portion located along the first surface of the elongated base member that includes a seat surface having a lip, a back surface and an end wall that is configured to receive the adapter clip such that the adapter clip is configured to abut the seat surface.

13. The adapter clip according to claim 12, wherein as the adapter clip is inserted into the recess portion, the first support arm is configured to abut against the end wall, the base member of the adapter clip is configured to abut against the back surface and the ridge profile is configured to fit within a groove positioned between the back surface and the lip such that the adapter clip can be selectively inserted and removed from the recess portion of the elongated base member.

14. The adapter clip according to claim 12 wherein the adapter clip further comprises a panel that extends from the second support arm and is adapted to allow a user to urge the panel away from the slope surface of the divider and remove the adapter clip from the recess portion.

15. The adapter clip according to claim 12 wherein the first support arm and the second support arm extend from the base member in a generally parallel configuration.

16. The adapter clip according to claim 13 wherein the first support arm further comprises a plurality of teeth extending in a direction away from the channel such that the teeth are configured to engage a plurality of corresponding teeth located along the end wall of the seat surface when the adapter clip is inserted into the recess portion.

17. The adapter clip according to claim 13 wherein the second support arm further comprises a plurality of teeth extending inwardly towards the channel such that the teeth are configured to engage a plurality of corresponding teeth located along a portion of the associated second type of rail when the associated second type of rail is inserted into the channel.

18. A method of connecting a divider adapted for use with a first type of rail to a second type of rail via an adapter clip, the method comprising:
providing a divider having an elongated base member with a first surface and an opposite second surface such that a divider wall extends from the second surface of the elongated base member;
providing a recess portion located along the first surface of the elongated base member, the recess portion includes a seat surface having a lip, a back surface and an end wall configured to connect to the first type of rail;
inserting an adapter clip into the recess portion along the seat surface, the adapter clip having a base member with a first end and an opposing second end such that a first support arm extends from the first end and a second support arm extends from the second end wherein the first support arm and second support arm extend from the base member and define a channel;
forcing a ridge profile positioned along at least one of the first end and the second end of the base member of the adapter clip against the lip of the recess portion to lock the adapter clip within the recess portion; and
coupling the divider to the second type of rail.

19. The method of connecting a divider adapted for use with a first type of rail to a second type of rail via an adapter clip according to claim 18, wherein the second type of rail is inserted into the channel of the adapter clip to couple the divider to a shelf.

20. The method of connecting a divider adapted for use with a first type of rail to a second type of rail via an adapter clip according to claim 18, further comprising the step of removing the adapter clip from the divider by depressing a panel member that extends from the second support arm of the adapter clip such that the ridge profile is released passed the lip of the recess portion.
